(19) United States
(12) Patent Application Publication
(10) Pub. No.: US 2002/0167184 A1
(43) Pub. Date: Nov. 14, 2002

(54) Superior stool tool II

(76) Inventor: Terrence M. May, (US)

Correspondence Address: FURRER & TEZAK, P.O. Box 1629, Mukilteo, WA, 98275, US

(21) Appl. No.: 10/124,059

(22) Filed: Apr. 16, 2002

Related U.S. Application Data
(60) Provisional application No. 60/286,447, filed on Apr. 25, 2001.

(51) Int. Cl. A01K 29/00; E01H 1/12

(52) U.S. Cl. 294/1.4; 294/55.5

(57) ABSTRACT

Provided in accordance with the present invention, there is disclosed a preferred embodiment of a Superior Stool Tool for improving the ease and sanitary conditions associated with removal of animal refuse from a surface, more specifically from grass surfaces wherein the grass may be higher than normal or wherein the grass has partial grown through the refuse. The invention includes a handled secured to a base portion, the handle providing a lever means, similar to a conventional shovel, for removing the refuse from the surface. The base portion generally includes a storage portion and a plurality of teeth secured to the base portion. In operation a user grasps the handle and forces the teeth under the refuse, thereby separating the refuse from the surface, and further sliding the refuse back onto the storage portion of the base portion.

### CROSS-REFERENCE TO RELATED APPLICATION

This application claims the benefit of U.S. Provisional Application, Serial No. 60/286,447, filed Apr. 25, 2001.

### FIELD OF THE INVENTION

The present invention relates, generally, to a device for conveniently and sanitarily scooping and disposing of debris, more specifically removing animal refuse from grass or other surfaces accessible by animals and, in particular, the invention relates to a scooping device having a plurality of teeth firmly secured to a base portion, the plurality of teeth providing the scoop function and the base portion acting as a storage component.

### BACKGROUND OF THE INVENTION

As animals become more and more integrated into human lives, particularly dogs that are walked or roam in city/urban environments, there is continually a need to improve the practices and methods of removing and disposing of animal waste, specifically, animal refuse. While there may have been a time in the past when animals, including dogs, could roam free with little or no concern by their owners regarding the animal waste, such is not the case today.

Today, in city environments, it is common to see pet owners walking or running with their favorite pets carrying a baggy or other material to pick up animal refuse. As such, the owner is required, to some degree, to touch and/or handle, although indirectly, the refuse. This method works, but does not let itself to the sanitary conditions that many owners would prefer given the option.

Alternatively, some pet owners may choose not to concern themselves with the animal refuse, leaving in for the property owner to contend with. Under such circumstances the property owner may not be dealing with the refuse of single animal, but of many animals that pass by or over the property in a given period of day. In this regard, it is very inconvenient for the property owner to use a baggy to extract the multiple refuse deposits from their property.

In addition, there are situation, specifically, where a dog or other animal is kept in a confined area. As such, the necessity to clean the area by removing the refuse can be an overwhelming task if the only tools available are a conventional rake and/or shovel, or a baggy as is often the case. Accordingly, there is a need for a tool that is convenient to use and limits or substantially removes the animal owner or concerned property owner from having any contact with the refuse. While the present invention has a strong application regarding large animals or pets such as dogs, it can be conveniently used in association with other animals including, but not necessarily limited to large birds (i.e., geese, etc.), cats and/or other animals that are pets or pests, as the case may be. In addition, while the present invention is designed with pet owners in mind, the tool may have other uses associated with gardens or other land type applications that the individual use may see fit.

While other devices have been devised to assist pet owners in dealing with animal refuse, such devices have not been adequate in dealing with refuse in grass or on other surfaces wherein the refuse may be difficult to remove. As for example, U.S. Pat. Nos.: 4,279,437; 4,316,627; and 5,360,247, and U.S. Design Pat. Nos.: 209,660 and 316,315, show devices that may be used in removing refuse, however none of these devices operate in a manner similar to the manner is which a user would utilize a conventional shovel. Specifically, such named devices may work well in removing refuse from smooth surfaces such as pavement, gravel, concrete, etc., but such devices are not well suited for removing refuse from grass, particularly grass that is longer than freshly cut grass, or has partially grown through the refuse.

From a review of U.S. Pat. No. 4,316,627, such limitations are apparent in that the teeth function more like flexible rake teeth. If such a device were used where the refuse is embedded in a grass surface or partially grown through with grass, the tongs of the device would have sufficient spring action wherein upon raising the device, when the refuse final breaks free, it will, more than likely, be thrown by the spring action of the teeth. In addition, there is a certain amount of complexity, including moving components, of the other above-named devices that renders them more difficult to operate than a shovel like device per se, and durability is likewise limited.

The device shown in U.S. Pat. No. 5360,247, while being fairly simple and rugged—if constructed from durable materials—uses a side motion rather than a forward thrusting motion, thus limiting the force that may be applied to both force the device under the refuse and to lift it from the surface.

### SUMMARY OF THE INVENTION

Provided in accordance with the present invention is a refuse tool that is simple in construction, convenient to use, and useful for handling and disposing of animal refuse. The tool of the present invention functions much like a conventional shovel—or similar device—using the same techniques of thrusting and lifting actions used with the shovel. The present invention overcomes the disadvantages of prior devices (and methods) for removing refuse from a surface, by providing a rugged tool that generally comprises a handle similar to a shovel handle and a base portion that may resemble some base portions found on conventional shovels. The base portion may be configured in a variety of configuration, but preferably includes some type of pan or bottom with raised edges for holding/storing the refuse once removed from the surface. Secured to and an integral part of the base portion are a plurality of teeth, the tips of the teeth, in the preferred embodiment, forming a partial curve, similar to the curve that one might expect to see on a shovel blade.

The tool portion itself is designed to conveniently remove refuse from grassy areas, specifically grassy areas that are perhaps taller than a conventionally or newly mowed law, or wherein the refuse has been on the surface for an extended period of time, and is partially grown through with grass (i.e., the refuse is combined with the grass). The device of the present invention facilitates a user in removing refuse from a surface, particularly a grass surface, without breaking up the refuse in the process, or complicating the process by “flipping” the refuse about as a result of extensive force being applied to flexible teeth of currently available devices.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a perspective view of a preferred embodiment of the present invention, showing a handle secured to a base portion, the base portion having a plurality of teeth attached thereto;

FIG. 2 illustrates an elevated front view of the preferred embodiment of the present invention, showing the handle secured to the base portion, the base portion having the plurality of teeth attached thereto;

FIG. 3 illustrates an elevated rear view of the preferred embodiment of the present invention, showing the handle secured to the base portion;

FIG. 4 illustrates an elevated side view of the preferred embodiment of the present invention, showing the handle secured to the base portion, the base portion having the plurality of teeth attached thereto;

FIG. 5 illustrates an elevated side view of the preferred embodiment of the present invention, showing the handle secured to the base portion, the base portion having the plurality of teeth attached thereto, FIG. 4 and FIG. 5 showing the symmetrical configuration of the present invention;

FIG. 6 illustrates an elevated bottom view of the preferred embodiment of the present invention, showing the handle secured to the base portion, the base portion having the plurality of teeth attached thereto; and

FIG. 7 illustrates an elevated top view of the preferred embodiment of the present invention, showing the handle secured to the base portion, the base portion having the plurality of teeth attached thereto.

### DETAILED DESCRIPTION OF THE PREFERRED EMBODIMENTS

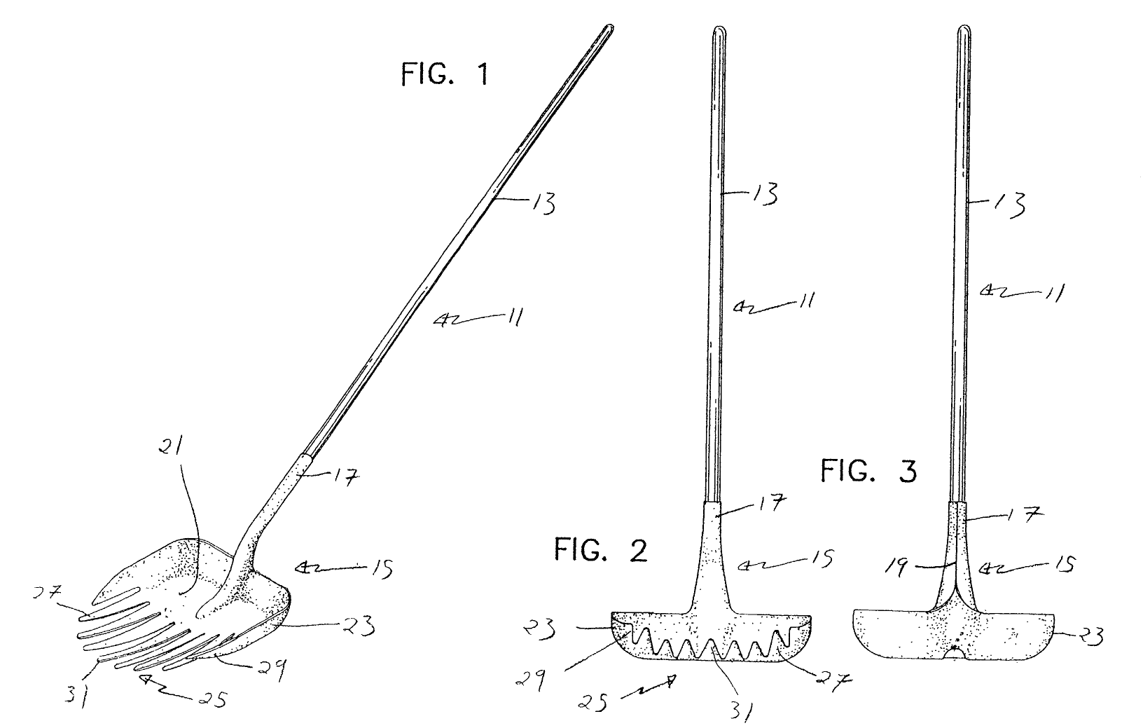

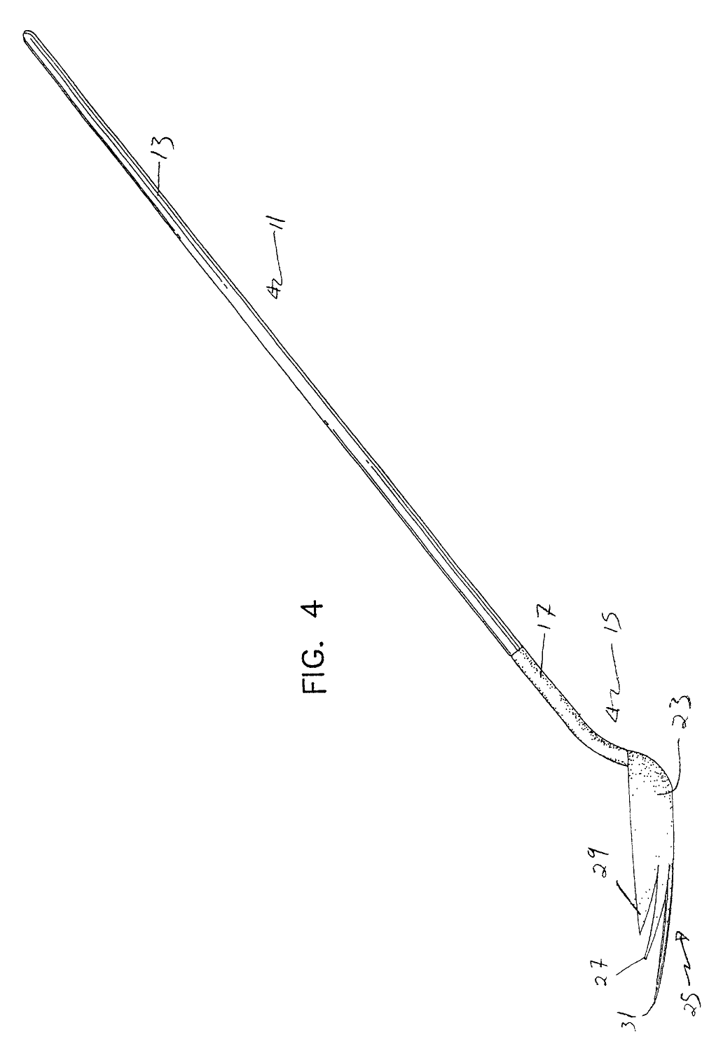

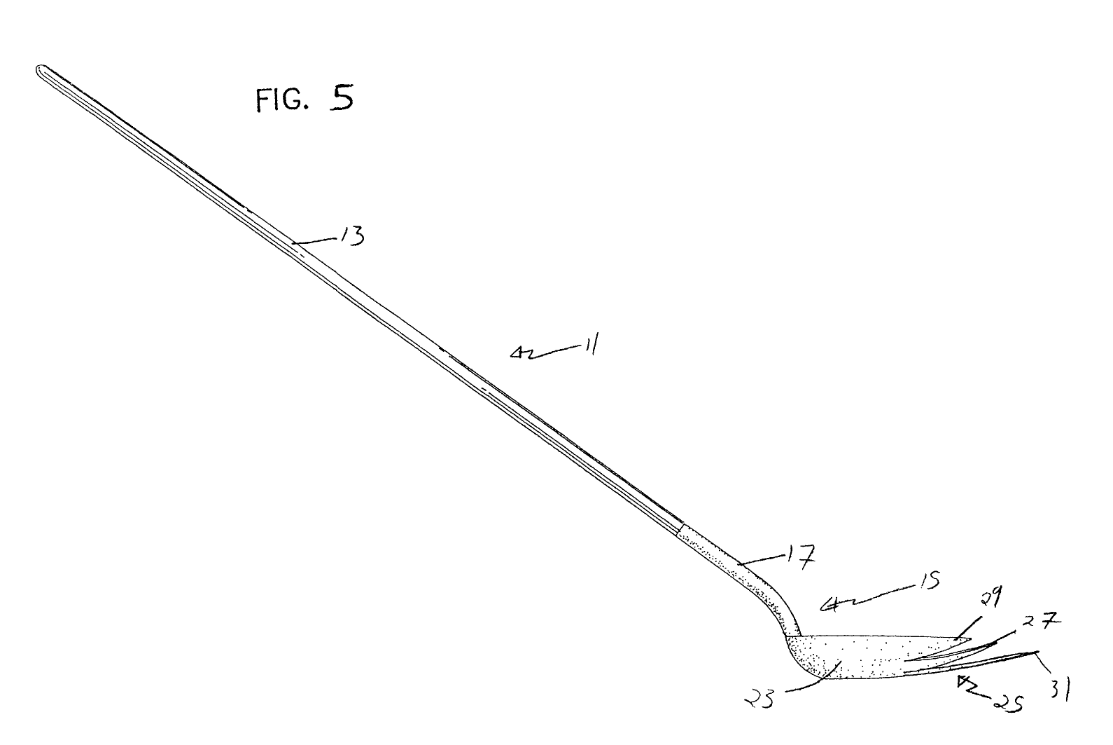

Referring now to FIG. 1 through FIG. 7 there is shown the preferred embodiment of the present invention. Specifically, the tool 11 of the present invention includes a handle 13 that may be comprised of a variety of materials, including, but not necessarily limited to, wood, plastic, composite and/or metal. Those skilled in the art will recognized that the handle 13 would be construct to best fit the application, whether it be for strength, cost savings or other factors relevant to a particular application. In addition, the handle 13 may be designed to telescope or fold into a compact configuration for carrying. While it is not shown in the drawings, the handle 13 may also include a grip assistant means commonly found on conventional shovels.

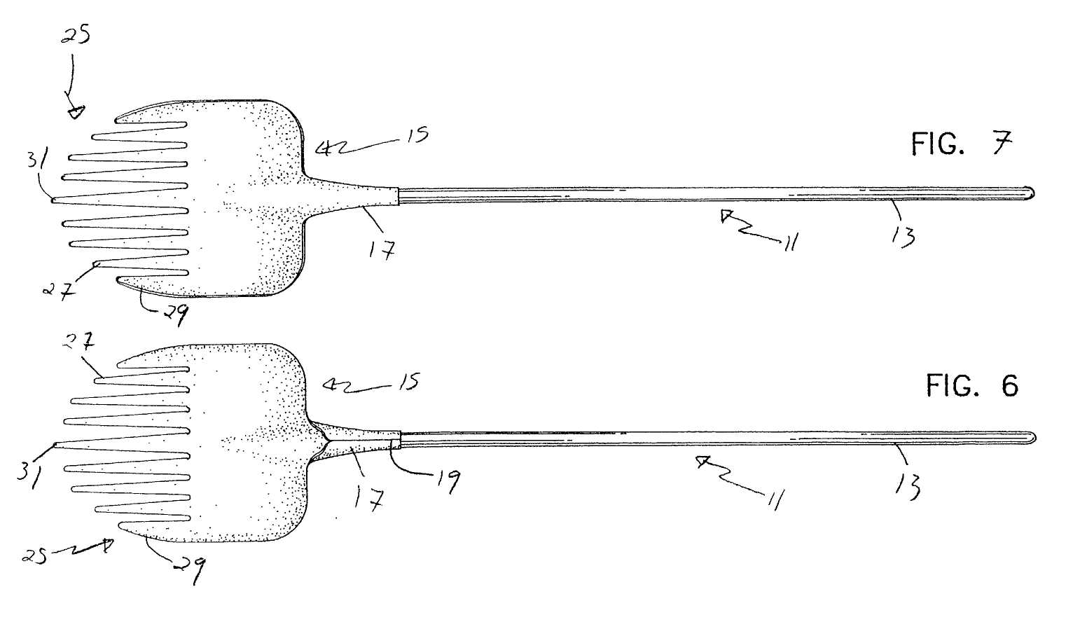

Attached to the handle 13 is a refuse portion 15 having a stem 17 for securing the handle 13 to the refuse removal portion 15. The refuse removal portion 15 may be secured to the handle 13 in a variety of methods that would be apparent to those skilled in the art, however, for purposes of simplicity, the present invention is shown wherein the stem 17 of the refuse removal portion 15 includes a split 19 in the stem 17 (this is shown in FIG. 3 and FIG. 6). Accordingly, the inside diameter of the stem 17 can be increased to fit over the handle 13. Once the handle 13 and the stem 17 have been combined, the stem 17 can be snugly tightened about the handle 13 using a bold, rivet or other securing means as would be readily apparent to those skilled in the art; such means are not shown in the Figures.

The refuse removal portion 15, best shown in FIG. 1 for purposes of description, includes a base portion 21 generally surrounded by a rim portion 23. In the preferred embodiment of the present invention, the base portion 21 serves the function of receiving, carrying and/or storage of the refuse (not shown), while the rim portion 23 serves the purpose of keeping the refuse contained on the base portion 21. While the embodiments shown in the Figures are preferred, any number of combination between the base portion 21 and the rim portion 23, including eliminating the rim portion 23, may be embodied based on design and intended use. It is the intent of the present invention to cover any such combinations that may be devised.

Integral with the base portion 21 and, to some extent, the rim portion 23, are a plurality of teeth 25. Generally, the plurality of teeth 25 include outer teeth 27, rim teeth 29 and inner teeth 31. As shown in the Figures, the plurality of teeth 25 are generally symmetrically about a lateral axis defined by an extension of the handle 13 extended through the base portion 21 and the plurality of teeth 25. In the preferred embodiment of the present invention, the plurality of teeth 25 are curved with the outer teeth 27 shorter than the inner teeth 31 and longer than the rim teeth 29. As is apparent to those skilled in the art, an infinite number of combinations between the outer teeth 27, the rim teeth 29 and the inner teeth 31 can be configured for any particular use or application.

In use, the user applies techniques to the operation of the tool 11 similar to using a conventional shovel. Specifically, the user places the inner teeth 31 in close proximity to the refuse, applies a forward thrusting action and then lifts the refuse from the surface. The refuse is thus slid onto the base portion 21 where it can be temporarily stored while additional refuse is removed from the surface. After which, or as the user sees fit, the refuse may be placed in a suitable container or disposal receptacle.

While a preferred embodiment of the invention has been illustrated and described, it will be appreciated that various changes can be made therein while remaining within the scope of the invention. Since changes can be made to the described embodiments of the invention, the invention should be defined only by reference to the claims of the invention.

The embodiments of the invention in which an exclusive property or privilege is claimed are defined as follows:

1. A device for removing animal refuse debris from a surface comprising:
(a) a handle for being grasped by a user; and
(b) a refuse removal portion having a base portion and a plurality of teeth integrally combined with said base portion, said handle being secured to one end of said base portion, and said plurality of teeth extending outwardly from said base portion opposite to the end of the base portion having said the handle secured thereto, wherein said plurality of teeth have substantially the same rigidity as the base portion.

2. The device according to claim 1 wherein said base portion further comprises, a rim portion extending around a perimeter of said base portion, wherein the rim portion tapers on either side of the base portion in proximity of the plurality of teeth, wherein the termination of the rim portion on either side of the base portion forms the outer most teeth of the plurality of teeth on either side of the base portion.

3. The device according to claim 1 wherein the plurality of teeth are secured to the blade portion in a curved configuration, the outer plurality of teeth being shorter than the center plurality of teeth.
